(19) United States
(12) Patent Application Publication
(10) Pub. No.: US 2026/0309898 A1
(43) Pub. Date: Oct. 8, 2026

(54) OPTICAL ASSEMBLY

(71) Applicant: OPTOTUNE SWITZERLAND AG, Dietikon (CH)

(72) Inventors: David Andreas NIEDERER, Dietikon (CH); Stephan SMOLKA, Dietikon (CH); Christopher LANING, Dietikon (CH)

(73) Assignee: OPTOTUNE SWITZERLAND AG, Dietikon (CH)

(21) Appl. No.: 19/482,753

(22) PCT Filed: May 8, 2024
(86) PCT No.: PCT/EP2024/062760

§ 371 Date: Nov. 9, 2025

(30) Foreign Application Priority Data
May 10, 2023 (DE) 102023112243.6

(51) Int. Cl. G02B 3/14; G02B 1/11; G02B 1/14; G02B 3/02; G02B 15/14; G02B 26/00; G02C 7/08

(52) U.S. Cl. CPC G02B 3/14; G02B 1/11; G02B 1/14; G02B 3/02; G02B 15/142; G02B 26/004; G02B 2207/109; G02C 7/085

(57) ABSTRACT

The invention relates to an optical assembly (1) comprising a first and a second optical group (10, 20), wherein the first group (10) comprises a first rigid lens (11) and a first liquid lens portion (12) arranged on a first surface (11-1) of the first lens (11), wherein the second group (20) comprises a second rigid lens (21), wherein the first liquid lens portion (12) is arranged between the first and the second lens (11, 21) and comprises at least one deformable surface portion (12-1) facing towards a contact surface (20-2) of the second group (20), wherein the optical assembly (1) is configured to adopt a first and a second state (s1, s2), wherein in the first state (s1), a gap (30) is formed between the deformable surface portion (12-1) and the contact surface (20-2), wherein in the second state (s2), no such gap is formed.

The invention relates to an optical assembly comprising a first optical group and a second optical group arranged along an optical axis according to claim 1.

In bi-focals a comparably big volume percentage is required for the optical elements to provide an optical assembly that is configured to adopt a first and a second state that differ optically from each other.

An object of the present invention is to provide a two state repeatably, digitally tunable lens with a low mechanical complexity and small extent along the optical axis, wherein the optical assembly comprises simple, cost efficient and flexible elements that allow the use in true binary bi-focals.

The object is achieved by the device having the features of claim 1. Advantageous embodiments are described in the dependent claims.

According to a first aspect of the invention, an optical assembly comprises a first optical group and a second optical group arranged along an optical axis, wherein the first optical group comprises a first rigid lens and a first liquid lens portion that is arranged on and particularly formed along a first surface of the first rigid lens, wherein the second optical group comprises a second rigid lens, wherein the first liquid lens portion is arranged between the first and the second rigid lens and comprises at least one deformable surface portion facing towards a contact surface of the second optical group, wherein the optical assembly, particularly the first optical group and the second optical group, is configured to adopt a first state and a second state, wherein in the first state, a gap along the optical axis is formed between the deformable surface portion of the first liquid lens portion and the contact surface of the second optical group, wherein in the second state, the deformable surface portion of the first liquid lens portion abuts the contact surface of the second optical group and assumes a contact shape in a contact region of the contact surface of the second optical group.

The optical assembly according to the invention allows for robustness rivalling current glasses, while offering a simple design with liquid tuning lenses, i.e. liquid lens portion(s). The first and the second state may be pre-set selectively and freely, depending on the specific application and the desired optical properties.

Particularly, the contact surface of the second optical group is located on a side of the second rigid lens that faces toward the first rigid lens.

According to another embodiment of the invention, the first optical group and the second optical group are configured to non-transiently adopt a first state and a second state.

The first and the second rigid lens may be made of glass or a polymer.

The first and the second state may be distinguished by a different distance between the first and the second lens along the optical axis, particularly wherein the distance in the first state is greater than in the second state.

Particularly in the first state, the distance is so wide that the gap along the optical axis is formed between the deformable surface portion of the first liquid lens portion and the contact surface of the second optical group, wherein in the second state, the distance is so small that the deformable surface portion of the first liquid lens portion is deformed and abuts the contact surface of the second optical group and assumes the contact shape in a contact region of the contact surface.

The invention provides an optical assembly that may alter its optical properties, particularly its optical power, between the first and the second state, in a very defined way. The invention may be used in simple, robust digital bifocals.

Particularly, a size of the first liquid lens portion is adjusted such that in the second state of the optical assembly an active optical area of the optical assembly and in particular of the second optical group is completely contacted by the deformable surface portion of the first liquid lens portion.

Particularly, the deformable surface portion of the first liquid lens portion may be considered to comprise a contact surface of the first optical group.

Therefore, in the current specification the term “contact surface of the second optical group” may be referred to as “second contact surface” as well.

Similarly, the term “contact surface of the first optical group” may be referred to as “first contact surface” equivalently.

To this end, the term “deformable surface portion of the first liquid lens portion” may be referred to as “first deformable surface portion” and the term “deformable surface portion of the second liquid lens portion” may be referred to as “second deformable surface portion”.

According to another embodiment of the invention, the second rigid lens comprises a first and a second surface, wherein the second optical group comprises a second liquid lens portion arranged between the second lens and the first lens, wherein the second liquid lens portion is arranged on and particularly formed along the second surface of the second lens, wherein the second liquid lens portion comprises at least one deformable surface portion facing towards the deformable surface portion of the first liquid lens portion, wherein the deformable surface portion of the second liquid lens portion forms the contact surface of the second optical group.

That is, the second optical group comprises a second liquid lens portion with a second deformable surface portion, namely the deformable surface portion of the second liquid lens portion, wherein the second deformable surface portion forms the second contact surface, which corresponds to the contact surface of the second optical group.

This embodiment allows for smaller liquid portions, and quasi-symmetrical manufacturing.

According to this embodiment the first and the second contact surface abut each other in the second state and are formed by the respective first and second deformable surface portions.

According to another embodiment of the invention, the first and the second liquid lens portions have the same size, particularly wherein the first and the second liquid lens portion comprise the same volume.

According to another embodiment of the invention, the first and/or the second liquid lens portion comprise a fluid, such as a liquid or a gel, enclosed in the respective liquid lens portion.

According to another embodiment of the invention, wherein the first and/or the second lens comprise(s) a non-circular, particularly a non-round circumference.

This embodiment relates to a shape of the first and/or the second rigid lens that may not be circular but in essence elliptic, or oval or comprises corners. These corners may have around contour.

Due to the liquid lens portion(s) of the optical assembly, the shape of the first and or the second rigid lens may be selected comparably free, without interfering with the optical properties of the optical assembly.

According to another embodiment of the invention, the first and/or the second liquid lens portion comprises a non-circular, particularly a non-round circumference.

This embodiment allows to have identically-shaped and sized circumferences of the rigid lenses and the associated lens portions.

Particularly, the first rigid lens and the first liquid lens portion are shaped identically and have the same size.

Particularly, the second rigid lens and the first liquid lens portion are shaped identically and have the same size.

According to another embodiment of the invention the first liquid lens portion, the first rigid lens, and the second rigid lens and particularly the second liquid lens portion have the same shape and size.

According to another embodiment of the invention, the optical assembly is configured to adopt two states only, namely the first and the second state.

This embodiment allows for a binary state assembly, that is switchable, particularly repeatedly switchable between first and the second state. This allows for greater comfort and facile handling of the optical assembly, particularly in case the optical assembly is comprised or functions as a bifocal.

According to another embodiment of the invention, in the first state, the gap separates the first deformable surface portion and the second contact surface along the entire first deformable surface portion.

That is, in this embodiment there is no contact between the first liquid lens portion and the second contact surface.

This allows a clear separation of the optical properties of the optical assembly.

According to another embodiment of the invention, the second contact surface extends around the optical axis, i.e. the optical axis crosses the second contact surface and a point of intersection is comprised by the second contact surface.

According to another embodiment of the invention, wherein the first deformable surface portion comprises or consists of a first transparent membrane, wherein the first transparent membrane is preloaded such that the first transparent membrane exhibits a smooth surface at least in the first state of the optical assembly, and/or wherein the second deformable surface portion comprises or consists of a second transparent membrane, wherein the second transparent membrane is preloaded such that the second transparent membrane exhibits a smooth surface at least in the first state of the optical assembly.

Preloading the transparent membrane allows for well-defined optical properties and avoids any folds that would interfere with optical quality of the optical assembly.

According to another embodiment of the invention, the first liquid lens portion comprises a first transparent fluid, such as a liquid and/or a gel, that is arranged between the first surface of the first lens and the deformable surface portion of the first liquid lens portion, and/or wherein the second liquid lens portion comprises a second transparent fluid, such as a liquid and/or a gel, that is arranged between the second surface of the second lens and the deformable surface portion of the second liquid lens portion, particularly wherein the first and the second fluid are identical.

According to another embodiment of the invention, the first transparent membrane is sealed to the first surface of the first rigid lens, such that the first fluid is in contact with the first surface of the first rigid lens, particularly wherein the first fluid is completely enclosed by the first transparent membrane and the first surface of the first rigid lens, and/or wherein the second transparent membrane of the second liquid lens portion is sealed to the second surface of the second lens, such that the second fluid is in contact with the second surface of the second lens, particularly wherein the second fluid of the second lens portion is completely enclosed by the second transparent membrane and the second surface of the second lens.

An alternative embodiment, which allows a simpler manufacturing of the first and/or the second optical group is disclosed in one of the following embodiments.

According to another embodiment of the invention, the first transparent membrane completely encloses the first fluid, particularly such that the first fluid is not in touch with the first surface of the first lens, and/or second transparent membrane completely encloses the second fluid, particularly such that the second fluid is not in touch with the second surface of the second lens.

This embodiment allows to premanufacture the first and/or the liquid lens portion.

Such a liquid lens portion may be a fluid-filled cushion like element, that can be glued or in other ways attached to the first and/or the second rigid lens accordingly.

For this purpose, the first and/or the second transparent membrane may be composed of several membrane portions that are sealingly connected, e.g. glued or welded with each other to form an enclosure of the first and the second fluid respectively.

According to another embodiment of the invention, the gap is gas-filled, particularly air filled. This embodiment comprises the notion of the gap consisting of air. The optical assembly can comprise a reservoir volume attached on one side of the optical assembly, which is connected to the gap to keep a gas pressure of the gas in the gap essentially constant.

According to another embodiment of the invention, the optical assembly is configured to move the first optical group relatively to the second optical group such as to change its configuration from the first to the second state and particularly vice versa, more particularly repeatedly.

For this purpose, the optical assembly may comprise one or more actuator elements.

According to another embodiment of the invention, the optical assembly is configured to move the first optical group relatively to the second optical group along the optical axis only such as to change its configuration from the first to the second state and particularly vice versa, more particularly repeatedly.

According to another embodiment of the invention, the optical assembly is configured to tilt the first optical group relatively to the second optical group around the optical axis.

According to some embodiments, it is possible to translationally move and tilt the first optical group with respect to the second group.

According to another embodiment of the invention, the optical assembly is configured to deform the first optical group relatively and/or the second optical group.

Each degree of freedom of the motion may be associated with a selected actuator element.

According to another embodiment of the invention, in the second state of the optical assembly the contact region comprises at least 10%, preferably more than 50%, of a free aperture area of the first liquid lens portion, and/or at least 10%, preferably more than 50%, of a free aperture area of the second liquid lens portion.

This embodiment defines an effective free aperture for the optical assembly, that is defined by the size of the contact region that is equally big or smaller than the free aperture of each free aperture area of the first and/or the second liquid lens portion.

Particularly, the free aperture area may be the optical aperture of the first or second rigid lens, respectively.

The contact region is the region at which the first deformable surface portion, i.e. the first contact surface abuts to the contact surface of the second optical group, i.e. the second contact surface.

The second contact surface may comprise the second deformable surface portion, if the optical assembly comprises a second liquid lens portion, otherwise the second contact surface may by comprised by the second surface of the second rigid lens.

According to another embodiment of the invention, the optical assembly comprises one or more springs adapted and arranged to apply a restoring force to the first and/or the second optical group pointing at least partially from the first state to the second state or vice versa. The one or more springs may be considered as actuator element(s).

This embodiment provides a cost-efficient means for the optical assembly to adopt the first and the second state. Reversing the states may be achieved by a force, e.g. manual or automatic, that overcomes the restoring force.

Alternatively, the optical assembly comprises a spring assembly that is adapted and arranged to exhibit bi-stable characteristic with a first and a second stable state, wherein in the first state of the spring assembly a force directed to keep or preload the optical assembly in the first state is generated and the second state of the spring assembly a force directed to keep or preload the optical assembly in the second state is generated. Transition between the two states of the spring assembly may require overcoming a threshold force of the spring assembly. This embodiment allows for a cost efficient and robust switching of the optical assembly between the first and the second state.

According to another embodiment of the invention, the first state and/or the second state of the optical assembly are stable.

This embodiment relates to an optical assembly that requires application of a mechanical force for switching the optical assembly from the first to the second state as well as a force for switching the optical assembly from the second state to the first state, i.e. the two states are separated by a local minimum in the potential energy, such that a bi-stable assembly is obtained, that requires a force to switch between the states.

According to another embodiment of the invention, the optical assembly is configured to adopt a non-transient third state.

According to another embodiment of the invention, the first surface of the first rigid lens and/or the second surface of the second rigid lens have/has a meniscus-shaped curvature.

According to another embodiment of the invention, the first rigid lens and/or the second rigid lens is/are configured to correct optical aberrations of at least a fourth order Zernike polynomial aberration.

This allows for manufacturing bi-focals comprising aberration corrections.

Particularly, astigmatism may be corrected by the rigid lens(es).

According to another embodiment of the invention, the second rigid lens is designed to be non-destructively interchangeable form the optical assembly.

This allows for a modular design of the optical assembly.

According to another embodiment of the invention, the deformable surface portion of the first liquid lens portion, particularly the first membrane of the first liquid lens portion, comprises an anti-reflection coating and/or an anti-scratch coating, particularly on a side facing towards the second rigid lens, and/or wherein the deformable surface portion of the second liquid lens portion, particularly the second membrane of the second liquid lens portion comprises an anti-reflection coating an anti-scratch coating, particularly on a side facing towards the first rigid lens.

This embodiment allows for a robust optical assembly having reduced optical losses.

According to another embodiment of the invention, the first rigid lens and/or the second rigid lens comprise(s) waveguide diffraction gratings.

This embodiment allows for a compact design of the optical assembly.

According to another embodiment of the invention, the first rigid lens and/or the second rigid lens is/are configured as a waveguide(s) and/or meta lens(es).

This embodiment allows for advanced and particularly slim optical assemblies with specific optical properties.

According to another embodiment of the invention, the first and/or the second liquid lens portion is/are configured to adjust a height and width, wherein the height extend along the optical axis and the width orthogonally to the optical axis, wherein in the first state the height is greater than in the second state, and the width is smaller in the first state than in the second state.

According to another embodiment of the invention, in the first state the first and/or the second deformable surface are convex with respect to the first and/or second liquid lens portion.

According to another embodiment of the invention, in the second state the first and/or the second deformable surface assume the shape of the first and/or the second contact surface, particularly wherein the first and/or the second contact surface is flat at least in the contact region.

According to another embodiment of the invention, the optical assembly comprises a particle protection lip configured to protect the contact region against particles.

The protection lip may be formed circumferential around the gap.

According to another embodiment of the invention, the protection lip may comprise an elastic material.

According to another embodiment of the invention, the second rigid lens comprises a gel coating, which is in contact with the first liquid lens portion in the second state.

The gel coating may prevent formation of bubbles between the first and the second contact surface.

### FIGURE DESCRIPTION

Particularly, exemplary embodiments are described below in conjunction with the Figures. The Figures are appended to the claims and are accompanied by text explaining individual features of the shown embodiments and aspects of the present invention. Each individual feature shown in the Figures and/or mentioned in said text of the Figures may be incorporated (also in an isolated fashion) into a claim relating to the device according to the present invention.

FIG. 1 shows a first embodiment of the invention;

FIG. 2 shows a second embodiment of the invention; and

FIG. 3 shows a third embodiment of the invention.

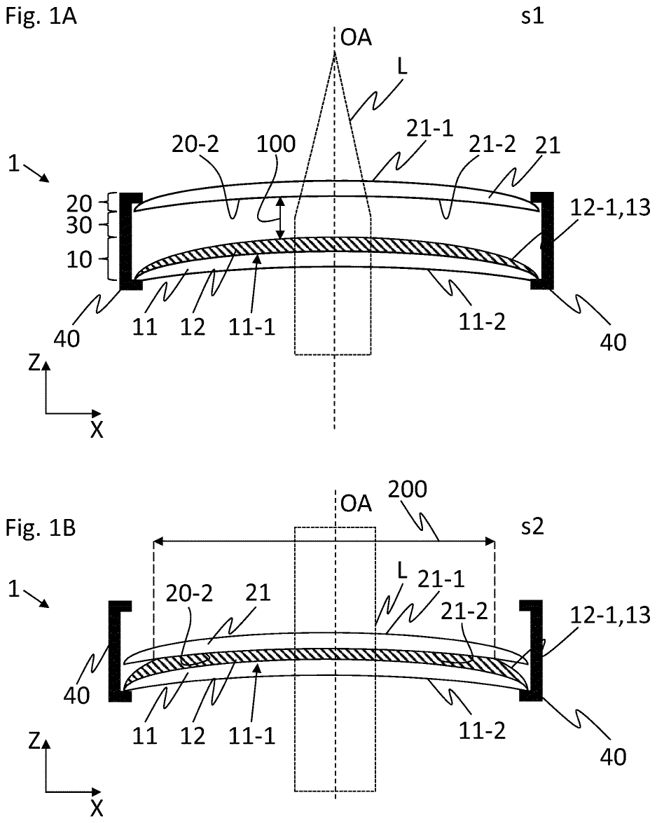

In FIG. 1 a schematic cross-section of an exemplary embodiment of the invention is shown. The cross-section extends along an x-z plane, that comprises the optical axis OA.

Without limitation, the optical axis OA is assumed to extend along the z-axis in all exemplary embodiments.

In panel A) of FIG. 1 the optical assembly 1 is depicted in a first state s1 and in FIG. 1 panel B) the optical assembly is depicted in the second state s2.

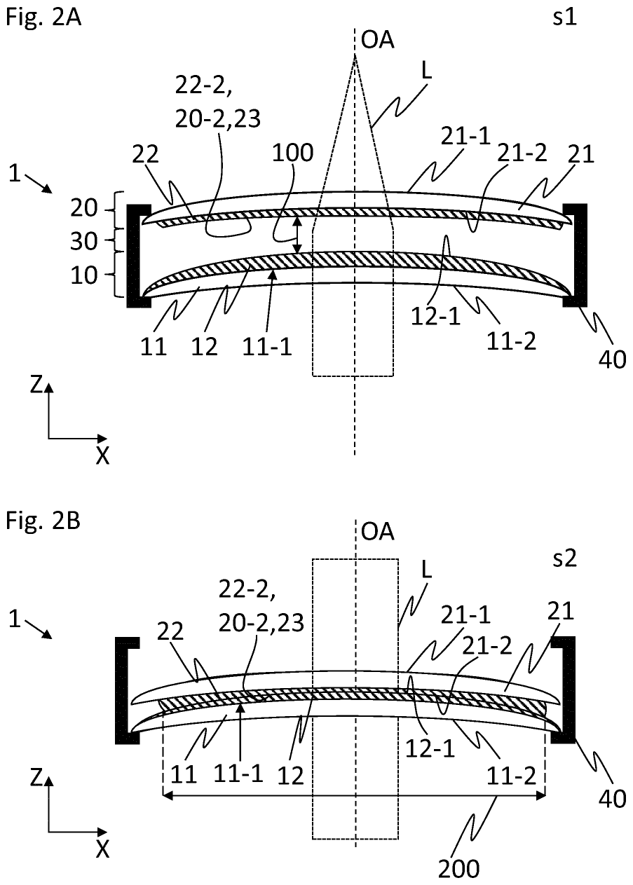

The same is true for FIG. 2

The optical assembly 1 of FIG. 1 comprises 1 a first optical group 10 and a second optical group 20. The first optical group 10 comprises a first rigid lens 11 and a first liquid lens portion 12. The second optical group 20 in FIG. 1 consists of a second rigid lens 21.

The first optical group 10 and the second optical group 20 are centered around the optical axis OA of the optical assembly 1 and are comprised by a frame 40 that limits a distance 100 between the first and the second optical group 10, 20.

The first rigid lens 11 comprises a first surface 11-1 and a second surface 11-2, wherein the first surface 11-1 faces towards the second optical group 20. On the second surface 11-2 of the first rigid lens 11, the first liquid lens portion 12 is arranged. Particularly, the first liquid lens portion 12 covers the majority of said first surface 11-1 of the first rigid lens 11. Moreover, the first liquid lens portion 12 extends also around the optical axis OA and in this particular embodiment is also centered around the optical axis OA, such that the first rigid lens 11 and the first liquid lens portion 12 are in essence concentrically arranged with respect to each other. It may be that the first liquid lens portion 12 covers the entire first surface 11-1 of the first rigid lens 11.

The first liquid lens portion 12 comprises a fluid such as a liquid or a gel with a refractive index that might be identical or at least close to the refractive index of the first and/or second rigid lens 21.

The first liquid lens portion 12 is therefore an optical element that adjusts the refractive properties of the first optical group 10, when the optical assembly 1 is in the first state s1.

The first liquid lens portion 12 comprises a deformable surface portion 12-1 which may be referred to the first deformable surface portion 12-1 in the current specification. The first deformable surface portion 12-1 faces toward the second optical group 20.

In the first state s1, an optical power and the optical properties of the first optical group 10 are defined by the combination of the first rigid lens 11 with the first liquid lens portion 12. Particularly, in case the refractive indices of the first rigid lens 11 and the first liquid lens portion 12 are identical or at least almost identical, the optical properties of the first optical group 10 are in essence defined by the shape of the first deformable surface portion 12-1 and the second surface 11-2 of the first rigid lens 11, as well as by a thickness (i.e. an extension along the optical axis OA) of the first optical group 10.

The first liquid lens portion 12 is a deformable element of the first optical group 10, wherein the first rigid lens 11 is not deformable.

The optical properties and the optical power of the optical assembly 1 are therefore given by the combination of the first optical group 10 and the second optical group 20. Now, in order to change the optical power and or the optical properties of the optical assembly 1, the invention provides that the first optical group 10 and the second optical group 20 are arranged movably with respect to each other along the optical axis OA. Furthermore, the optical assembly 1 is configured to adopt a first state s1 and a second state s2 which correspond to the first optical group 10 and the second optical group 20 having a different distance to each other along the optical axis OA.

According to the invention, the first and the second optical group 10,20 are arranged movable with respect to each other along the optical axis OA. In a first state s1, the distance 100 along the optical axis OA between the first and the second optical group 10,20 is greater than in the second state s2, wherein in the first state s1, the first optical group 10 is not in contact with the second optical group 20 at a contact surface 20-2, such that an air-filled gap 30 is formed between the first and the second group 10,20.

That means, in the first state s1, the first deformable surface portion 12-1 of the first liquid lens portion 12 is not in touch with the contact surface 20-2 of the second optical group 20. In the example of FIG. 1, the second rigid lens 21 comprises a first surface 21-1 and the second surface 21-2, wherein the second surface 21-2 faces towards the first optical group 10 and corresponds to the contact surface 20-2 of the second optical group 20. Thus, in the first state s1, the first deformable surface portion 12-1 is not in touch with the second surface 21-2 of the second rigid lens 21.

In the second state s2, however, the first deformable surface portion 12-1 abuts the contact surface 20-2 of the second optical group 20 and therefore is in contact with the second optical group 20 via said contact surface 20-2. Contacting takes place in a contact region 200 which may be smaller than the contact surface 20-2 but comprises at least 10% of the contact surface 20-2. The contact region 200 is typically centered around the optical axis OA and covers at least 50% of the free aperture of the first and/or the second rigid lens 11,21.

In the second state s2, the first and the second optical group 10,20 are in contact such that the deformable surface portion 12-1 of the first liquid lens portion 12 is adjusted with regard to its shape. Due to the pressure that might be exerted on the first deformable surface portion 12-1 and the first liquid lens portion 12, the fluid of the first liquid lens portion 12 may rearrange in the first liquid lens portion 12 such that the first liquid lens portion 12 changes its shape. In particular, in the contact region 200, the first deformable surface portion 12 has a shape that corresponds to a shape of the contact surface 20-2 in the contact region 200.

Due to the change of shape of the first deformable surface portion 12-1 and the adjusted distance between the first and the second optical group 10,20 the optical properties of the optical assembly 1 are adjusted.

The invention therefore provides an optical assembly 1 having at least two states, wherein said optical assembly 1 may be selectively adjusted to adopt the first or the second state s1,22, wherein the first and the second state s1,s2 differ in their optical properties particular in their optical power of the optical assembly 1.

The first deformable surface portion 12-1 may consist of a first elastically deformable transparent membrane 13. In essence there are two differing embodiments of the first liquid lens portion 12. A first embodiment may have the fluid enclosed completely and solely by said first transparent membrane 13, such that the first liquid lens portion 12 is a cushion-like element with the fluid completely enclosed by a cover, namely the first membrane 13. A second embodiment of the first liquid lens portion provides that the fluid is enclosed by the first transparent membrane 13 on one side and on the other side the fluid is enclosed by the first surface 11-1 of the first rigid lens 11.

The first membrane 13 should have a membrane surface facing to the second optical group 20 that exhibits low release forces from the contact surface 20-2. The first membrane 13 may comprise an antireflection and/or an anti-scratch coating for improved optical quality of the optical assembly 1.

The differing optical properties of the optical assembly 1 in the first and the second state s1, s2 are schematically depicted by a light beam L that in the first state s1 of the optical assembly 1 is in essence focused to a focal point, wherein in the second state s2 said light beam L remains parallel.

In FIG. 2 another exemplary embodiment is schematically depicted as a cross-section along the optical axis OA of the optical assembly 1.

The first optical group 10 comprises the same elements and components as the first optical group 10 of FIG. 1 and will therefore not be elaborated again.

In contrast to the embodiment shown in FIG. 1, the second optical group 20 of FIG. 2 comprises the second rigid lens 21 and a second liquid lens portion 22. The second liquid lens portion 22 is arranged on the second surface 21-2 of the second rigid lens 21 and faces towards the first optical group 10.

The second liquid lens portion 22 may be formed and/or arranged according to any of the embodiments relating to the first liquid lens portion 12. Particularly, the second liquid lens portion 22 comprises a fluid having a refractive index which may be identical or almost identical to the refractive index of the first and/or the second rigid lens 11,21. Moreover, the fluid might be a gel or the liquid.

The fluid of the second liquid lens portion 22 might be completely and entirely enclosed by a second elastically deformable and transparent membrane 23 or the fluid might be enclosed by the second surface 21-2 of the second rigid lens 21 and the second membrane 23.

Independently of that, the second liquid lens portion 22 comprises a deformable surface portion 22-2 (also referred to as “second deformable surface portion” in the current specification) that is formed by said second transparent membrane 23. The deformable surface portion 22-2 of the second liquid lens portion 22 forms the contact surface 20-2 of the second optical group 20.

Therefore, in the first state s1 of the optical assembly 1 there is a gap 30 between the first and the second liquid lens portion 12,22 along the optical axis OA. Only when the optical assembly 1 adopts the second state s2, the first deformable surface portion 12-1 and the second deformable surface portion 22-2 abut each other in the contact region 200 of the contact surface 20-2. In the second state s2, the fluid of the first and the second liquid lens portion 12,22 rearrange in the respective liquid lens portions such that both liquid lens portions 12,22 adjust their shape and form a contact surface 20-2 that in essence is defined by parameters such as the thickness and stiffness of the first and/or the second membrane 13,23 as well as shape of the first surface 11-1 of the first rigid lens 11 and the shape of the second surface 21-2 of the second rigid lens 21 as well as the viscosity of the fluids. There might be more parameters which define the shape of the contact surface 20-2 in the contact region 200 but it is clear that the moment the two liquid lens portions 12,22 contact each other over the contact region 200 and a pressure is applied along the optical axis OA, the fluids rearrange and are pushed away from the optical axis OA towards the rims of the liquid lens portions 12,22.

This embodiment allows a more versatile and flexible manufacturing and definition of the optical properties in the first and the second state s1,s2 of the optical assembly 1.

Such an optical assembly 1 might be used in bi-focals or other applications that require at least two focal or two optical states that are quickly adjustable.

In order to move the first optical group 10 and the second optical group 20 along the optical axis OA, the optical assembly 1 might comprise one or more actuator elements. These actuator elements are not shown in the figures but for the skilled person is clear that there are various ways to implement such actuator elements.

An example of an actuator element might be one or more springs or a spring assembly. It could be also any mechanical motor means such as a piston that might be electromagnetically driven and that moves at least one of the first or the second optical group relative to the other.

It is noted that apart from the relative motion of the first and second group along the optical axis it might be advantageous to also provide a tilting capability to the optical assembly which translates that the first and the second optical group might enclose different angles to each other in the first state and the second state, such that for example the optical axes of the first and second group align differently in the first and/or the second state. This tilting capability may be achieved by means of positioning elements.

It is noted that the stiffness of the first and/or the second deformable surface portion, in particular the first and/or the second membrane, may selected so high that gravity-induced deformations of the liquid lens portions are negligible.

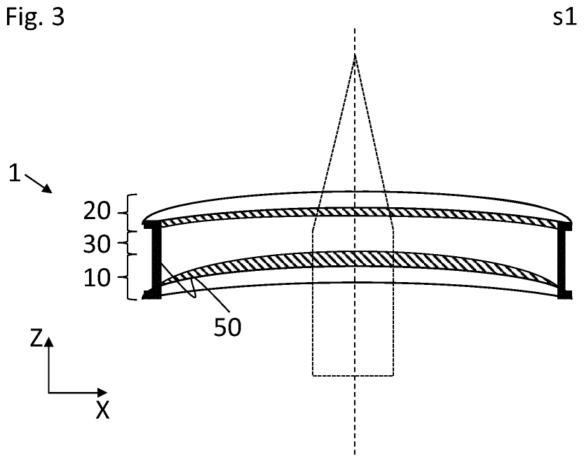

FIG. 3 shows a similar embodiment to FIG. 2, wherein the optical assembly 1 comprises an elastically deformable protective lip 50 that extends circumferentially around the gap 30 formed between the first and the second optical group 10,20. The lip 50 seals the space between the first and the second optical group 10,20 in a dust-tight fashion such that no dust may enter in the cavity between the first and the second optical group 10,20 in the first state s1.

### REFERENCE NUMERALS

1 optical assembly
10 first optical group
11 first rigid lens
11-1 first surface of first rigid lens
11-2 second surface of first rigid lens
12 first liquid lens portion
12-1 deformable surface portion of the first liquid lens portion
13 first membrane
20 second optical group
20-2 contact surface
21 second rigid lens
21-1 first surface of second rigid lens
21-2 second surface of second rigid lens
22 second liquid lens portion
22-2 deformable surface portion of the second liquid lens portion
23 second membrane
30 gap
40 frame
50 protective lip
100 distance
200 contact region
L light beam
OA optical axis
s1 first state
s2 second state

1. An optical assembly (1) comprising a first optical group (10) and a second optical group (20) arranged along an optical axis (OA), wherein the first optical group (10) comprises a first rigid lens (11) and a first liquid lens portion (12) that is arranged on a first surface (11-1) of the first rigid lens (11), wherein the second optical group (20) comprises a second rigid lens (21), wherein the first liquid lens portion (12) is arranged between the first and the second rigid lens (11, 21) and comprises at least one deformable surface portion (12-1) facing towards a contact surface (20-2) of the second optical group (20), wherein the optical assembly (1) is configured to adopt a first state (s1) and a second state (s2), wherein in the first state (s1), a gap (30) along the optical axis (OA) is formed between the deformable surface portion (12-1) of the first liquid lens portion (12) and the contact surface (20-2) of the second optical group (20), wherein in the second state (s2), the deformable surface portion (12-1) of the first liquid lens portion (12) abuts the contact surface (20-2) of the second optical group (20) and assumes a contact shape in a contact region (200) of the contact surface (20-2).

2. The optical assembly (1) according to claim 1, wherein the first state (s1) and/or the second state (s2) are stable.

3. The optical assembly (1) according to claim 1, wherein the second rigid lens (21) comprises a first (21-1) and a second surface (21-2), wherein the second optical group (20) comprises a second liquid lens portion (22) arranged between the rigid second lens (21) and the first rigid lens (11), wherein the second liquid lens portion (22) is arranged on the second surface (21-2) of the second rigid lens (21), wherein the second liquid lens portion (22) comprises a deformable surface portion (22-2) facing towards the deformable surface portion (12-1) of the first liquid lens portion (12), wherein the deformable surface portion (22-2) of the second liquid lens portion (22) forms the contact surface (20-2) of the second optical group (20).

4. The optical assembly (1) according to claim 1, wherein the first (11) and/or the second rigid lens (21) comprises a non-circular, particularly a non-round circumference.

5. The optical assembly (1) according to claim 1, wherein the first (12) and/or the second liquid lens portion (22) comprises a non-circular, particularly a non-round circumference.

6. The optical assembly (1) according to claim 1, wherein the optical assembly (1) is configured to adopt two states only, namely the first and the second state (s1, s2).

7. The optical assembly (1) according to claim 1, wherein in the first state (s1), the gap (30) separates the deformable surface portion (12-1) of the first liquid lens portion (12) and the contact surface (20-2) of the second optical group (20) along the entire deformable surface portion (12-1) of the first liquid lens portion (12).

8. The optical assembly (1) according to claim 1, wherein the deformable surface portion (12-1) of the first liquid lens portion (12) comprises or consists of a first transparent membrane (13), wherein the first transparent membrane (13) is preloaded such that the first transparent membrane (13) exhibits a smooth surface at least in the first state (s1) of the optical assembly (1), and/or wherein the deformable surface portion (22-2) of the second liquid lens portion (22) comprises or consists of a second transparent membrane (23), wherein the second transparent membrane (23) is preloaded such that the second transparent membrane (23) exhibits a smooth surface at least in the first state (s1) of the optical assembly (1).

9. The optical assembly (1) according to claim 1, wherein the first liquid lens portion (12) comprises a first transparent fluid, such as a liquid and/or a gel, that is arranged between the first surface (11-1) of the first rigid lens (11) and the deformable surface portion (12-1) of the first liquid lens portion (12), and/or wherein the second liquid lens portion (22) comprises a second transparent fluid, such as a liquid and/or a gel, that is arranged between the second surface (21-2) of the second lens (21) and the deformable surface portion (22-2) of the second liquid lens portion (22), particularly wherein the first and the second fluid are identical.

10. The optical assembly (1) according to claim 1, wherein the first transparent membrane (13) completely encloses the first fluid, particularly such that the first fluid is not in touch with the first surface (11-1) of the first rigid lens (11), and/or second transparent membrane (23) completely encloses the second fluid, particularly such that the second fluid is not in touch with the second surface (21-2) of the second rigid lens (21).

11. The optical assembly according to claim 1, wherein the gap (30) is gas-filled, particularly air filled.

12. The optical assembly (1) according to claim 1, wherein the optical assembly (1) is configured to move the first optical group (10) relatively to the second optical group (20) such as to change its configuration from the first (s1) to the second state (s2).

13. The optical assembly (1) according to claim 1, wherein in the second state (s2) the contact region (200) comprises at least 10%, preferably more than 50%, of a free aperture area of the first liquid lens portion (12), and/or at least 10%, preferably more than 50%, of a free aperture area of the second liquid lens portion (22).

14. The optical assembly (1) according to claim 1, wherein the optical assembly (1) comprises a spring adapted and arranged to apply a restoring force to the first (10) and/or the second optical group (20) pointing at least partially from the first state (s1) to the second state (s2) or vice versa.

15. The optical assembly (1) according to claim 1, wherein the first rigid lens (11) and/or the second rigid lens (21) is/are configured to correct optical aberrations of at least a fourth order Zernike polynomial aberration.

16. The optical assembly (1) according to claim 1, wherein the second rigid lens (21) is designed to be non-destructively interchangeable form the optical assembly.

17. The optical assembly (1) according to claim 8, wherein the deformable surface portion (12-1) of the first liquid lens portion (12) comprises an anti-reflection coating and/or an anti-scratch coating, particularly on a side facing towards the second rigid lens (21), and/or wherein the deformable surface portion (22-2) of the second liquid lens portion (22) comprises an anti-reflection coating an anti-scratch coating, on a side facing towards the first rigid lens (11).

18. The optical assembly (1) according to claim 1, wherein the first rigid lens (11) and/or the second rigid lens (21) comprise(s) waveguide diffraction gratings.

19. The optical assembly (1) according to claim 1, wherein the first rigid lens (11) and/or the second rigid lens (21) is/are configured as a waveguide(s) and/or meta lens(es).

20. The optical assembly (1) according to claim 1, the first and/or the second liquid lens portion (12, 22) is/are configured to adjust a height and width, wherein the height extend along the optical axis (OA) and the width orthogonally to the optical axis (OA), wherein in the first state (s1), the height is greater than in the second state (s2), and the width is smaller in the first state (s1) than in the second state (s2).

21. The optical assembly (1) according to claim 1, wherein the optical assembly (1) comprises a particle protection lip (40) configured to protect the contact region (200) against particles.

22. The optical assembly (1) according to claim 1, wherein the second rigid lens (21) comprises a gel coating, which is in contact with the first liquid lens portion (12) in the second state (s2).
